(19) United States
(12) Patent Application Publication
(10) Pub. No.: US 2025/0216036 A1
(43) Pub. Date: Jul. 3, 2025

(54) STARTUP CONTROL SYSTEM AND METHOD FOR CENTRIFUGAL COMPRESSORS

(71) Applicant: SAUDI ARABIAN OIL COMPANY, Dhahran (SA)

(72) Inventors: Turky Saleh ALSHUHAIL, Dhahran (SA); Jafar Sadiq ALYASEEN, Dammam (SA); Abdullah Ali ALALI, Dammam (SA)

(73) Assignee: SAUDI ARABIAN OIL COMPANY, Dhahran (SA)

(21) Appl. No.: 18/398,907

(22) Filed: Dec. 28, 2023

(51) Int. Cl. F17D 5/00; G05B 19/416

(52) U.S. Cl. CPC F17D 5/005; G05B 19/416; G05B 2219/37371

(57) ABSTRACT

A sales gas compressor system includes a gas compressor including a motor, a startup control line in fluid communication with the gas compressor to convey sales gas thereto, a flow control valve arranged in the startup control line and adjustable to alter sales gas flow during startup, and a control system in communication with the flow control valve and the motor. The control system includes a feedforward control loop that determines a suction pressure of the sales gas flowing to the gas compressor, and a feedback control loop that determines a current supplied to the motor. The control system determines a gas flow rate required by the gas compressor during startup and based on values obtained from the feedforward and feedback control loops, and control opening of the flow control valve to adjust the flow of the sales gas to the gas compressor based on the determined gas flow rate.

### FIELD OF THE DISCLOSURE

The present disclosure relates generally to centrifugal compressors and, more particularly, to a control system and method for adjusting gas flow to a sales gas compressor for safe startup of the compressor.

### BACKGROUND OF THE DISCLOSURE

In the oil and gas industry, natural gas extracted from underground hydrocarbon reservoirs must be processed for downstream use and consumption. Natural gas processing plants are generally configured to process “sour” natural gas to remove acid gases and produce clean natural gas, referred to as “sales gas,” and natural gas liquids (NGL). The acid gases are removed in an amine-based gas treating unit, and the resulting “sweet” gas is sent to one or more NGL recovery units where the light components (mainly methane) is separated from the heavier components (NGL) in a de-methanizer. In some applications, sales gas (mostly methane) leaves the top of the de-methanizer at a pressure of around 300 psig, and it is then conveyed to one or more three sales gas compressors operable to increase the pressure of the sales gas to approximately 800 psig before being sent to customers for consumption.

During startup of sales gas compressors, the sales gas is introduced to the sales gas compressor through a 24″ zone valve (ZV) located upstream of the sales gas compressor. This introduces a large amount of gas to the compressor, which requires high torque in order to adequately compress the sales gas. As a result of the high torque requirement, the motor of the sales gas compressor might trip due to a high current demand, which can delay the startup of the machine for hours and consequently may affect the plant's processing capacity. For example, on average, at least one sales gas compressor undergoes startup each year, and each compressor has a capacity to process about 400 million standard cubic feet per day (MMSCFD) of sales gas. A motor trip during startup could delay the compressor startup by 4 or more hours, thereby leading to a process capacity loss of about 67 MMSCF of sales gas, which equates to approximately $155,000 per year.

What is needed is new systems and/or methods configured to prevent a sales gas compressor from surging and motor trip due to high current during startup.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments of the present disclosure include a sales gas compressor system that includes a gas compressor that includes a motor, a startup control line in fluid communication with the gas compressor to convey sales gas to the gas compressor, a flow control valve arranged in the startup control line and selectively adjustable to alter a flow of the sales gas to the gas compressor during startup of the gas compressor, and a control system in communication with the flow control valve and the motor. The control system may include a feedforward control loop configured to determine a suction pressure of the sales gas flowing to the gas compressor, and a feedback control loop configured to determine a current supplied to the motor. The control system is programmed to determine a gas flow rate required by the gas compressor during startup and based on values obtained from the feedforward control loop and the feedback control loop, and control opening of the flow control valve to adjust the flow of the sales gas to the gas compressor based on the determined gas flow rate, to avoid surge and tripping of the motor.

Embodiments of the present disclosure further include a method of adjusting gas flow to a gas compressor during startup, the method may include the steps of determining, with a control system, a suction pressure of sales gas flowing to the gas compressor, determining, with the control system, a current supplied to a motor of the gas compressor, determining, with the control system, a gas flow rate required by the gas compressor during startup and based on the determined suction pressure and the current supplied to the motor, and controlling, with the control system, opening of a flow control valve to adjust a flow of the sales gas supplied to the gas compressor based on the determined gas flow rate, and thereby avoiding surge and tripping of the gas compressor during startup.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of an example sales gas compressor system that may incorporate the principles of the present disclosure.

FIG. 2 is a schematic diagram of the control system of FIG. 1, according to one or more embodiments of the present disclosure.

FIG. 3 is a method for adjusting a gas flow to the compressor during a startup period using the control device.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to centrifugal compressors and, more particularly, to a control system and method for adjusting gas flow to a sales gas compressor to ensure safe startup of the sales gas compressor. Conventional systems and methods that attempt to ensure safe startup of sales gas compressors include the use of a single feedback or a single feedforward loop configured to control startup operation of the compressor. Employing either a feedback loop or a feedforward loop, however, may increase an error margin. Moreover, existing systems use the same inlet line of the sales gas compressor to control the gas pressure, and using the same inlet line, which is large in size, may result in difficulties in controlling the gas pressure, thereby making the startup process unstable.

The embodiments disclosed herein describe systems and methods designed to overcome the above mentioned drawbacks, among others. The control systems described herein include a startup control line and a flow control valve, where the startup control line is coupled in parallel to an inlet supply line of the sales gas compressor, thereby forming a separate gas flow path to the compressor. The flow control valve arranged within the startup control line may be selectively adjusted to vary the gas flow supplied to the compressor during a startup process of the sales gas compressor.

Embodiments disclosed herein also described methods for adjusting gas flow to a sales gas compressor during startup by using the control systems briefly mentioned above. The method may include determining a suction pressure of a feed gas flowing to the sales gas compressor, and determining the real-time current supplied to a motor of the sales gas compressor. The gas flow rate required by the compressor during startup may then be determined based on the determined suction pressure and the current supplied to the motor. The control system may be programmed to control the opening of the flow control valve based on the determined gas flow rate to adjust the gas flow supplied to the compressor. This may prove advantageous in helping to avoid surge and tripping of the compressor during startup.

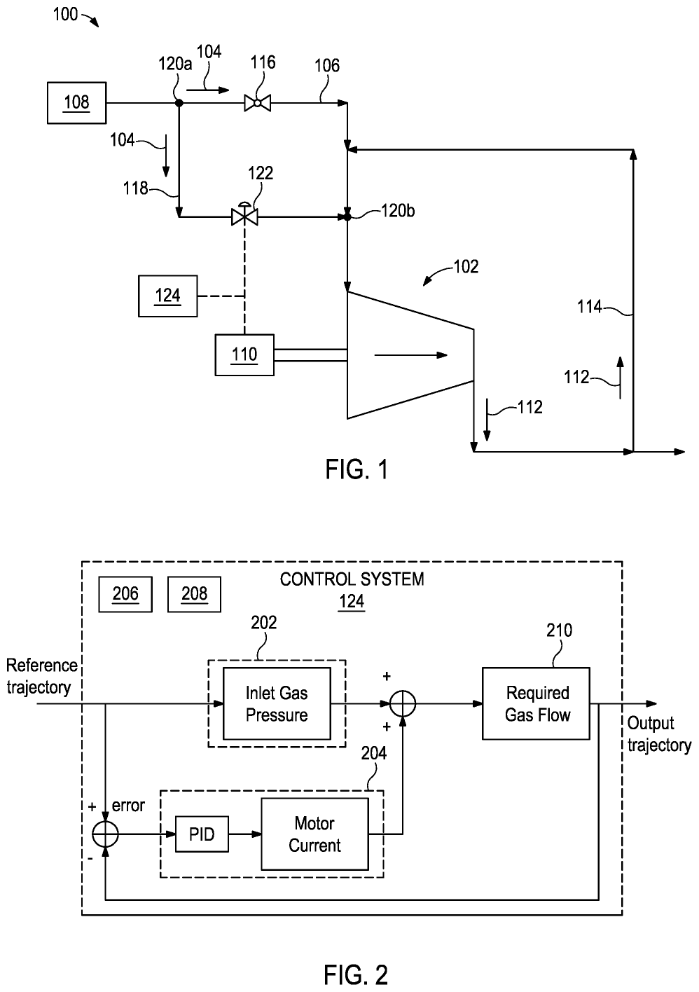

Referring to FIG. 1, illustrated is a schematic diagram of an example sales gas compressor system 100 that may incorporate the principles of the present disclosure. As illustrated, the sales gas compressor system 100 (hereafter “the system 100”) includes a gas compressor 102 arranged to receive a gas 104 via an inlet supply line 106 fluidly coupled to the gas compressor 102 and extending between a source 108 of the gas 104 and the gas compressor 102.

The gas compressor 102 includes a motor 110 configured to operate the gas compressor 102. In at least one embodiment, the gas compressor 102 may comprise a centrifugal compressor, but could alternatively comprise other types of compressors. The gas compressor 102 could be any compressor commonly used on a gas processing plant including, but not limited to, a feed gas compressor, a fuel gas compressor, or a propane compressor.

The gas 104 may comprise “sales” gas, which may constitute a natural gas mixture that includes at least 50% methane by weight of the mixture. The gas 104 will be referred to herein as “sales gas 104”. The source 108 of the sales gas 104 may comprise a de-methanizer included in a natural gas processing plant. In at least one embodiment, the system 100 may form part of the natural gas processing plant.

During operation of the system 100, compressed sales gas 112 may be discharged from the gas compressor 102 and conveyed downstream to customers for consumption. In some applications, a portion of the compressed sales gas 112 may be recycled back to the system 100 via a recycle line 114. The recycle line 114 may be used as an anti-surge feature and may include a valve operable to open when the minimum flow is reached to protect the gas compressor 102 from surging.

During example startup of the gas compressor 102, the sales gas 104 is introduced to the gas compressor 102 via the supply line 106. A zone valve 116 may be arranged in the supply line 106 upstream of the gas compressor 102 to regulate the flow of the sales gas 104 to the gas compressor 102. In some applications, the zone valve 116 may comprise a 24 inch valve, which may introduce a large flow or volume of the sales gas 104 to the gas compressor 102, which requires high torque to adequately compress the sales gas 104 at startup. As a result, the motor 110 might trip due to a high current demand, which can delay the startup process of the gas compressor 102.

According to embodiments of the present disclosure, the system 100 may further include a startup control line 118 fluidly coupled to the supply line 106 to provide sales gas 104 to the gas compressor 102. In particular, the startup control line 118 bypasses the zone valve 116 by extending between an upstream point 120a located upstream from the zone valve 116 and a downstream point 120b located downstream from the zone valve 116. In at least one embodiment, the startup control line 118 can be a 10 inch pipe or conduit, or could be larger than 10 inches, without departing from the scope of the disclosure. The startup control line 118 forms a gas flow path to the gas compressor 102 that may be used during a startup process for the gas compressor 102 when high torque is required to compress the sales gas 104.

The system 100 further includes a flow control valve 122 arranged in the startup control line 118 and selectively operable to automatically adjust the gas flow supplied to the gas compressor 102 during startup of the gas compressor 102. Operation of the flow control valve 122 may be controlled by a control system 124 in communication with the flow control valve 122, and also in communication with the motor 110. The control system 124 may be programmed with logic that includes both a feedforward control loop and a feedback control loop to determine the required gas flow to the gas compressor 102 during startup, while ensuring that the current supplied to the motor 110 does not exceed its maximum limit and thereby surge (trip). The feedforward loop is dependent on the inlet pressure of the sales gas 104 entering the gas compressor 102, while the feedback loop depends on the real-time measured current of the motor 110. Based on these determinations, the control system 124 may be programmed to selectively regulate the position (i.e., open, closed, or any magnitude therebetween) of the flow control valve 122, and thereby selectively adjust the gas flow supplied to the gas compressor 102.

Referring to FIG. 2, with continued reference to FIG. 1, depicted is a schematic diagram of the control system 124, according to one or more embodiments of the present disclosure. As illustrated, the control system 124 includes a feedforward control loop 202 and a feedback control loop 204 used to intelligently operate the flow control valve 122 during startup of the gas compressor 102. The control system 124 may further include a processor 206 and memory 208 that has machine-readable instructions stored thereon, which, when executed by the processor 206 can cause the feedforward control loop 202 to determine a suction pressure (inlet gas pressure) of the sales gas 104 flowing to the gas compressor 102, and cause the feedback control loop 204 to determine a real-time current supplied to the motor 110 of the gas compressor 102.

More specifically, in one or more embodiments, the control system 124 is configured to determine a gas flow rate required by the gas compressor 102 during the startup process of the gas compressor 102, as depicted at 210. The required gas flow rate is determined based on a combination of values obtained from the feedforward control loop 202 and the feedback control loop 204. The control system 124 is configured with threshold values (depicted as “Reference trajectory”) of the suction pressure of the gas compressor 102 and the current supplied to the motor 110 of the gas compressor 102. These threshold values may be stored in the memory 208 and exhibit values (magnitudes) that ensure that the suction pressure of the gas compressor 102 is maintained above its minimum pressure, and that the current supplied to the motor 110 is below the maximum allowable limit. The control system 124 is further configured to control operation (i.e., opening, closing, or any magnitude therebetween) of the flow control valve 110 based on the determined gas flow rate to adjust the gas flow supplied to the gas compressor 102, shown in FIG. 2 as “Output trajectory”. In operation, this protects the gas compressor 102 from surging and further helps prevent the motor 110 from tripping due to high current during startup.

The gas flow rate required by the gas compressor 102 to maintain the minimum pressure depends on the pressure of the sales gas 104 at the inlet to the gas compressor 102, which can be calculated using the following formulas:

$$H = \frac{P - 1 \text{.05} {P}_{min}}{ρ g}$$

$$Q = \sqrt{\frac{H}{s L}}$$

where s is the resistivity of the startup control line 118 as calculated by the Sheverev formula; L is the length of the startup control line 118; H is the difference in head between the flow control valve 122 and the inlet to the gas compressor 102; Pₘᵢₙ is the minimum suction pressure to protect the gas compressor 102 from surging; P is the pressure of the sales gas 104 going to the gas compressor 102, p is the density of the sales gas 104, g is the gravitational acceleration, and Q is the required flow rate to the gas compressor 102 during startup. In some cases, as included in the first formula, 5% is added to Pₘᵢₙ to ensure protection against surging.

During example startup of the gas compressor 102, and following the introduction of the sales gas 104 to the system 100, the opening of the flow control valve 122 can be tuned based on a real-time current reading of the motor 110 using the feedback loop 204. The feedback loop 204 enables the control system 124 to control the current of the motor 110 to avoid tripping of the gas compressor 102 during startup. This adjustment cannot be implemented if the suction pressure of the gas compressor 102 is less than the minimum value to avoid compressor surge.

The zone valve 116 may be closed during the startup process. Since the gas compressor 102 would be initially shut down, the zone valve 116 may also be closed and it will not be opened until the gas compressor 102 is started and flow to gas compressor 102 is stable. Once stable flow to the gas compressor 102 is established, the zone valve 116 may be opened while simultaneously closing control valve 122 until the normal feed rate is established and the control valve 122 is completely closed. In some embodiments, opening the zone valve 116 while simultaneously closing the control valve 122 may be done manually. In other embodiments, however, the zone valve 116 may also be in communication with the control system 124, which may be programmed to cause the zone valve 116 to be opened while simultaneously closing the control valve 122.

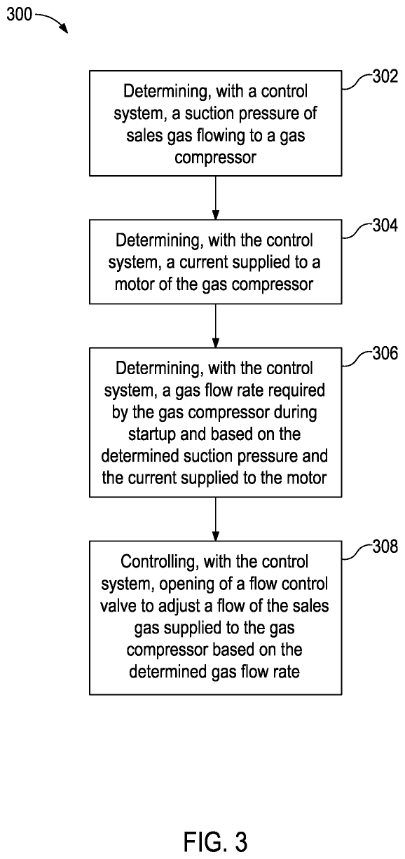

FIG. 3 is a schematic flowchart of an example method 300 of adjusting gas flow to a gas compressor 102 during startup, according one or more embodiments. The method 300 may be best understood with reference to FIGS. 1-2 and the corresponding description. As illustrated, the method 300 may include determining, with a control system 124, a suction pressure of sales gas 104 flowing to the gas compressor 102, as at 302. The control system 124 includes the processor 206 and the memory 208 that has machine-readable instructions stored thereon, which, when executed by the processor 208 causes the control system 124 to determine the suction pressure of the sales gas 104. In at least one embodiment, the suction pressure of the sales gas may be determined using the feedforward control loop 202 of the control system 124.

The method 300 may further include determining, with the control system 124, a current supplied to the motor 110 of the gas compressor 102, as at 304. When the machine-readable instructions stored on the memory 308 are executed by the processor 208, the control system 124 can be caused to determine the current supplied to the motor 110. In at least one embodiment, the current may be determined using the feedback loop 204 of the control system 124.

The method 300 may then include determining, with the control system 124, a gas flow rate required by the gas compressor 102 during startup and based on the determined suction pressure and the current supplied to the motor 110, as at 306. The method 300 may then include controlling, with the control system 124, opening of a flow control valve 122 to adjust a flow of the sales gas 104 supplied to the gas compressor 102 based on the determined gas flow rate, as at 308, and thereby avoiding surge and tripping of the gas compressor during startup.

The various actions in method 300 may be performed in the order presented, in a different order, or simultaneously. Further, in some embodiments, some actions or steps listed in FIG. 3 may be omitted.

The proposed startup control device 104 can be implemented to different types of centrifugal compressors which encounter high current issues during startups. The proposed startup control device 104 can be preferably applicable to sales gas compressors that require high torque during startup. The proposed startup control device 104 can avoid delay of the compressor startup by approximately 4 hours, due to motor trip, which is a process capacity loss of about 67 MMSCF of sales gas. Thus, the startup control device 104 provides an equivalent cost avoidance of approximately $155,000/year.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or device or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

Use of the terms “coupled” or “coupled to” or “connected” or “connected to” or “attached” or “attached to” may indicate establishing either a direct or indirect connection, and is not limited to either unless expressly referenced as such.

The invention claimed is:

1. A sales gas compressor system, comprising:
a gas compressor that includes a motor;
a startup control line in fluid communication with the gas compressor to convey sales gas to the gas compressor;
a flow control valve arranged in the startup control line and selectively adjustable to alter a flow of the sales gas to the gas compressor during startup of the gas compressor; and
a control system in communication with the flow control valve and the motor, the control system including:
a feedforward control loop configured to determine a suction pressure of the sales gas flowing to the gas compressor; and
a feedback control loop configured to determine a current supplied to the motor, wherein the control system is programmed to:
determine a gas flow rate required by the gas compressor during startup and based on values obtained from the feedforward control loop and the feedback control loop; and
control opening of the flow control valve to adjust the flow of the sales gas to the gas compressor based on the determined gas flow rate, to avoid surge and tripping of the motor.

2. The system of claim 1, wherein the gas compressor comprises a centrifugal compressor.

3. The system of claim 1, further comprising:
an inlet supply line extending between a source of the sales gas and the gas compressor to convey the sales gas to the gas compressor during operation; and
a zone valve arranged in the inlet supply line, wherein the startup control line bypasses the zone valve.

4. The system of claim 3, wherein the startup control line is fluidly coupled to the supply line at an upstream point located upstream from the zone valve and a downstream point located downstream from the zone valve.

5. The system of claim 3, wherein the zone valve is closed during startup of the gas compressor.

6. The system of claim 1, wherein the startup control line comprises a 10 inch pipe or larger.

7. The system of claim 1, wherein the control system further includes a processor and memory that has machine-readable instructions stored thereon, which, when executed by the processor causes the feedforward control loop to determine the suction pressure of the sales gas flowing to the gas compressor, and causes the feedback control loop to determine the current supplied to the motor.

8. The system of claim 6, wherein threshold values of the suction pressure and the current are stored on the memory to ensure that the suction pressure of the gas compressor is maintained above a minimum pressure, and that the current supplied to the motor is below a maximum allowable limit.

9. A method of adjusting gas flow to a gas compressor during startup, the method comprising:
determining, with a control system, a suction pressure of sales gas flowing to the gas compressor;
determining, with the control system, a current supplied to a motor of the gas compressor;
determining, with the control system, a gas flow rate required by the gas compressor during startup and based on the determined suction pressure and the current supplied to the motor; and
controlling, with the control system, opening of a flow control valve to adjust a flow of the sales gas supplied to the gas compressor based on the determined gas flow rate, and thereby avoiding surge and tripping of the gas compressor during startup.

10. The method of claim 9, wherein the flow control valve is arranged in a startup control line in fluid communication with the gas compressor.

11. The method of claim 9, wherein the startup control line bypasses a zone valve arranged in an inlet supply line extending between a source of the sales gas and the gas compressor, the method further comprising:
closing the zone valve during startup of the gas compressor; and
opening the zone valve while simultaneously closing the flow control valve once the flow of the sales gas to the gas compressor stabilizes.

12. The method of claim 9, wherein the control system includes a processor and memory that has machine-readable instructions stored thereon, which, when executed by the processor causes the control system to determine the suction pressure of the sales gas, and causes the control system to determine the current supplied to the motor.

13. The method of claim 12, wherein determining the suction pressure of the sales gas comprises determining the suction pressure with a feedforward control loop of the control system.

14. The method of claim 12, wherein determining the current supplied to the motor comprises determining the current using a feedback control loop of the control system.

15. The method of claim 12, further comprising storing threshold values of the suction pressure and the current on the memory and thereby ensuring that the suction pressure of the gas compressor is maintained above a minimum pressure, and that the current supplied to the motor is below a maximum allowable limit.
